(19) United States
(12) Patent Application Publication
(10) Pub. No.: US 2009/0252158 A1
(43) Pub. Date: Oct. 8, 2009

(54) APPLICATION SERVER ALLOWING THE DISTRIBUTION OF A CALL INTENDED FOR A TERMINAL CONNECTED TO A GATEWAY TO ALL TERMINALS CONNECTED TO THIS GATEWAY

(75) Inventors: Maria Laura Maag, Nozay (FR); Johann Daigremont, Nozay (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/414,933

(22) Filed: Mar. 31, 2009

(30) Foreign Application Priority Data
Apr. 4, 2008 (FR) 0852261

(51) Int. Cl. H04L 12/66

(52) U.S. Cl. 370/352

(57) ABSTRACT

According to the invention, an application server (AS) for a telecommunication network (IPN) supporting the SIP protocol, includes:
means for receiving (41) a request to set up a call to a number identifying a gateway (RGW),
means for then interrogating (42) another device (LS) in such a way as to receive (43) from this other device (LS) a number for each mobile telephone (T1) connected to this gateway,
and means for requesting (47) that a call control device (CC) sets up a call to one or more telephones (T1) identified by numbers selected from among the numbers received in this way.

### TECHNICAL FIELD

The invention concerns an application server for a telecommunication network supporting the SIP (Session Initiation Protocol) signaling protocol and providing a combination of at least three services: traditional telephony over Internet protocol, mobile telephony over Internet protocol, and Internet access. Television may also be offered, but this invention does not apply to it. To benefit from this combination of services, users have, in their home, a residential gateway connected to a traditional telecommunication network through an ADSL line (Asymmetrical Digital Subscriber Line) or a television distribution cable, supporting the Internet protocol. In this home, this gateway may be connected to:
one (or more) traditional telephone(s) (in other words intended for connection to an analog interface) with a wireline connection, this traditional telephone can be wired or wireline, of the type DECT (Digital Enhanced Cordless Telephone) for example,
one (or more) WiFi mobile telephones, in other words connected by a WiFi connection to a WiFi access point connected to or integrated in the residential gateway,
a personal computer running in particular a telephony software, through a wireline or WiFi connection,
possibly a television, through a wireline or WiFi connection.

The personal computer and the WiFi mobile telephone send and receive telephone signals in the form of data packets compliant with the Internet protocols family. The residential gateway converts an analog signal provided by the traditional telephone into data packets compliant with the Internet protocols family, then sends them to the network; in turn, it receives such packets sent by the network and converts them into an analog signal which can be accepted by the traditional telephone.

The invention more specifically concerns the event in which a user is at home and can therefore use a WiFi mobile telephone. This mobile telephone may also be a dual-mode, cellular-WiFi telephone, used in WiFi mode. In the following, WiFi mobile telephone will be used to refer both to a WiFi telephone and to a WiFi-cellular dual-mode telephone. Traditional telephone will refer to any telephone which can be connected to an analog interface of the residential gateway using a wireline or wireless connection. The invention also applies to any other type of mobile telephone which can be connected to a residential gateway via a local wireless network, for example a Bluetooth type telephone.

Users subscribing to this combination of at least three services may be called on the traditional telephone by dialing a number specific to this traditional telephone, and belonging to the numbering plan of the traditional network. Users with a WiFi mobile telephone may be called on this WiFi mobile telephone by dialing a number specific to this WiFi mobile telephone, and also belonging to the numbering plan of the traditional network. In the first case, the traditional telephone is the only one which rings and which allows the taking of the call. In the second case, the WiFi telephone is the only one which rings and which allows the taking of the call.

When a home has several residents who use this combination of services, each person may have their own WiFi mobile telephone. A single residential gateway can support, outgoing and incoming, several calls simultaneously, on several WiFi mobile telephones respectively, each of these WiFi mobile telephones having an individual number belonging to the traditional network numbering plan. The traditional telephone of this home also has a specific individual number, therefore separate from the number of the WiFi mobile telephone or the numbers of the WiFi mobile telephones which can be connected to the same gateway. There may even be several traditional telephones connected to a single residential gateway, and having either the same number, or different numbers allowing independent calls.

### BACKGROUND

Let us consider the simple case in which a single traditional telephone and a single WiFi mobile telephone are connected to the same residential gateway. When someone wishes to call a user living in this home, they must choose between calling the traditional telephone number or calling the WiFi mobile telephone number of this user. In the first case, only the traditional telephone rings. In the second case, only the WiFi mobile telephone of the user rings; therefore no other user can answer on their behalf, even in cases where this may be desirable.

A known method to resolve this disadvantage involves requesting, from the requesting terminal, the setting up of a three party call to simultaneously ring the WiFi mobile telephone and the traditional telephone. This method is not practical, however, since it requires the caller to carry out additional operations. Furthermore, the caller cannot know which WiFi mobile telephone is present in this home.

A first aim of the invention is to allow at least the WiFi mobile telephone located in this home to be rung when a caller dials the directory number of the traditional telephone of this home.

A second aim of the invention is to simultaneously ring at least one traditional telephone and one WiFi mobile telephone located in this home when a caller dials the directory number of this traditional telephone.
A third aim of the invention is to allow the called user to choose from various options:
   ringing only the fixed telephone of this user, connected to the gateway,
   ringing only the WiFi telephone of this user, connected to the gateway,
   simultaneously ringing the traditional telephone (or the traditional telephones) and the WiFi mobile telephone of this user, connected to the gateway,
   or simultaneously ringing at least one traditional telephone and all the WiFi mobile telephones which are connected to the gateway,
      when a caller dials the directory number of the traditional telephone.

A first objective of the invention is an application server for a telecommunication network supporting the SIP protocol, comprising:
means for receiving a request to set up a call to a number identifying a gateway,
means for then interrogating another device by sending it the number identifying this gateway, so as to receive from this other device at least one number designating a telephone connected to this gateway,
and means for requesting that a call control device sets up at least one call to at least one telephone identified by a number received in this way;

and characterized in that the means for requesting that a call control device set up at least one call comprise means for selecting at least one number from a range of numbers respectively designating telephones connected to this gateway, then requesting the setup of a call to each telephone designated by a number selected in this way.

According to a first embodiment, the means for selecting always select all numbers respectively designating telephones connected to this gateway.

According to a preferred embodiment, it also includes means for allowing a user to configure this server in such a way as to select in advance one or more telephones from among the telephones connected to said gateway.

The server characterized in this way is used to ring at least one telephone selected from among a range of telephones located on the same premises. For example, it may ring a WiFi mobile telephone when someone calls the number corresponding to a traditional telephone, since the WiFi mobile telephone number may be found from the traditional telephone number, due to the association of the two numbers in the memory of the server; and because a user can configure this server in such a way as to select in advance the mobile telephone from the two telephones connected to the gateway. As a result, this provides the advantages of the WiFi telephone (in particular its mobility in the WiFi coverage area), even if the caller is calling the traditional telephone number.

The server characterized in this way also allows ringing of both a WiFi mobile telephone and a traditional telephone, by dialing only the number corresponding to the traditional telephone, since the WiFi mobile telephone number can be found and located from the traditional telephone number, due to the association of the two numbers in the server memory, and due to the fact that the application server has been configured in advance to select these two numbers together, so as to set up two calls: one call to the traditional telephone and one call to the WiFi mobile telephone. The called user may take the call on the traditional telephone or on their WiFi mobile telephone.

The fact that the traditional telephone and the WiFi mobile telephone ring at the same time is sometimes disruptive. For example, at certain times a user may prefer to discreetly receive calls on their WiFi telephone only, to avoid the ringing of the traditional telephone (or traditional telephones) disturbing other people present in the house.

The means for selecting one number from among several enable a user to configure this server, at any time, so that this server requests:
either the setting up of multiple calls respectively to all telephones identified by the numbers received in this way,
or the setting up of one call only to a pre-determined mobile telephone, identified by a number received in this way,
or the setting up of one call only to a pre-determined traditional telephone, identified by a number received in this way.

The invention also has the objective of a location server for terminals connected to a residential gateway, for a telecommunication network supporting the SIP protocol, characterized in that it contains:
means for storing and associating:
   a gateway identifier,
   and a range of numbers respectively identifying a range of telephones connected to this gateway,
means for receiving, from another device, a request containing a gateway identifier,
and means for sending in this case to this other device a range of numbers identifying telephones connected to the gateway identified by this gateway identifier, with these numbers being read in the storage means.

### BRIEF DESCRIPTION OF THE DRAWINGS

The invention will be better understood and other characteristics will appear with the help of the description below and the accompanying figures:

FIG. 1 shows in diagram form the subscriber equipment in a home equipped with a residential gateway connected, via a traditional public network, to another SIP type public network and comprising an embodiment example of the application server, according to the invention, and an embodiment example of the location server for terminals connected to a residential gateway, according to the invention.

FIG. 2 shows in diagram form a SIP (Session Initiation Protocol) type telecommunication network, which is not the IMS (Internet Protocol Multimedia Subsystem) type.

FIG. 3 shows in diagram form a SIP type telecommunication network, more specifically of the IMS type.

FIG. 4 shows a time diagram for signal exchanges during the operation of an embodiment example of the application server and of the location server for terminals connected to a residential gateway according to the invention.

### DESCRIPTION OF EMBODIMENTS

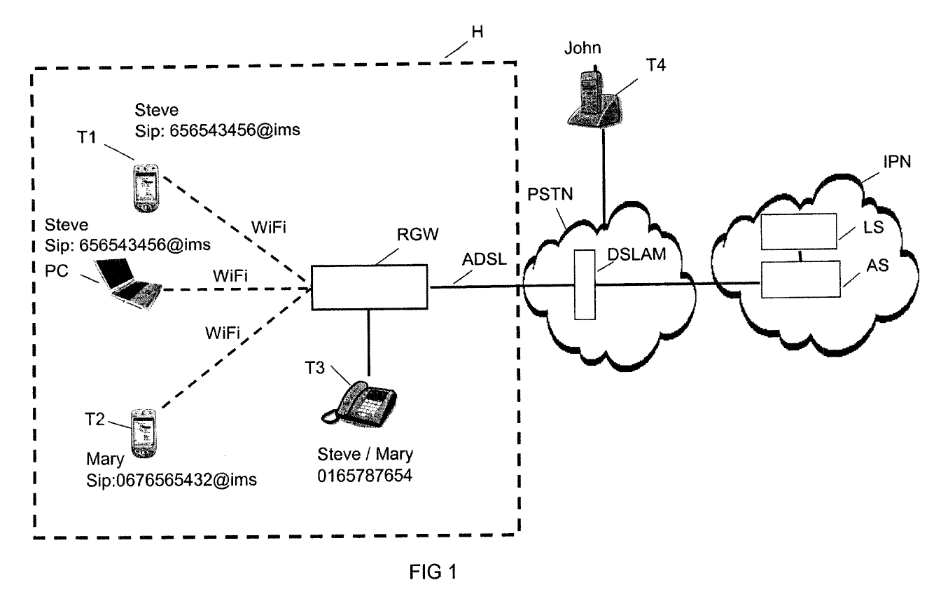

In the example shown in FIG. 1, a home H is connected to a traditional public network PSTN by a residential gateway RGW and an asymmetrical digital subscriber line, with the reference ADSL on the figures. The traditional network PSTN comprises an access multiplexer-demultiplexer for asymmetrical digital subscriber lines, with the reference DSLAM, which allows residential gateways such as the RGW gateway to access another public network IPN supporting the Internet protocol and the SIP protocol. This IPN network comprises an embodiment example AS of the application server, according to the invention, and an embodiment example LS of the location server for terminals connected to a residential gateway, according to the invention.

The home H comprises the following subscriber equipment which is connected to the RGW gateway:
a cellular-WiFi dual-mode mobile telephone T1, belonging to Steve, with the number 0656543456 in a global cellular network and with the sip number: 0656543456@ims in the IPN network;
a cellular-WiFi dual-mode mobile telephone T2, belonging to Mary, with the number 0676565432 in the global cellular network and with the sip number: 0676565432@ims in the IPN network;
and a traditional analog wireline telephone, T3, which can be used by Steve and Mary, and with the number 0165787654 in the traditional public network PSTN.

The residential gateway RGW comprises an analog interface for the traditional telephone T3, and a WiFi access point to which several WiFi mobile terminals can connect. It is connected to the traditional telephone T3 by a wire, and to the WiFi cellular telephones T1, T2 and to the PC through WiFi connections.

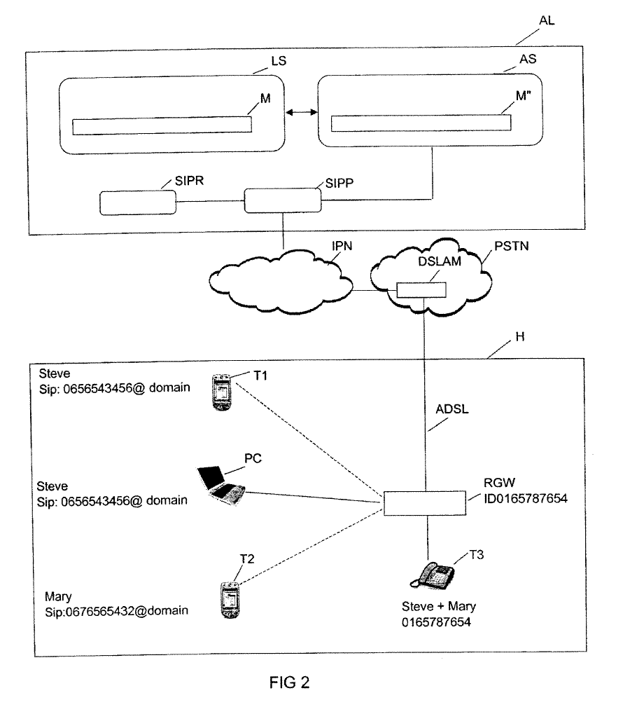

Let us consider a user, John, who has any kind of telephone T4 connected to the traditional public network PSTN. With his telephone T4, John calls Steve, for example, by dialing the number 0165787654 of the traditional telephone T3, in the numbering plan of the traditional network PSTN. FIGS. 2 to 4 show how a call is set up, ringing both Steve's WiFi mobile telephone T1, Mary's WiFi mobile telephone T2, and the traditional telephone T3, if Steve has chosen this option.

FIG. 2 shows in diagram form a SIP (Session Initiation Protocol) type telecommunication network, which is not the IMS (Internet Protocol Multimedia Subsystem) type. It comprises a Service Provider layer, SP, comprising essentially a SIP registrar server SIPR, a SIP proxy server SIPP, a telephony application server AS, and a location server LS. A traditional registrar server SIPR and proxy server SIPP are used.

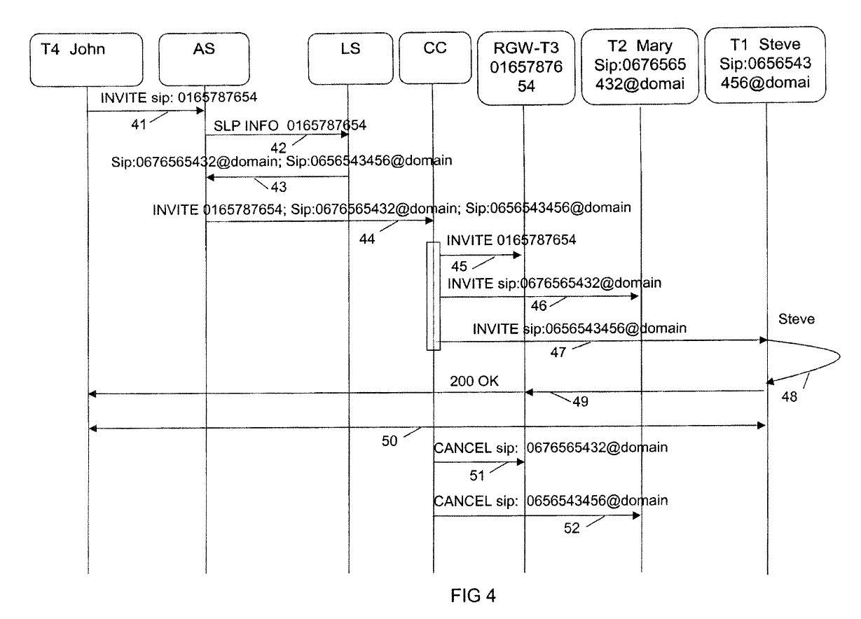

The application server AS is an embodiment example of the application server according to the invention, which comprises software means for asking the location server LS which WiFi telephones are currently connected to a given residential gateway, at the time a call has to be set up via this residential gateway; then asking a call control device to set up calls. These functions will be described later, referring to FIG. 4. The application server AS comprises a memory M″ containing the gateway identifier, the number identifying the traditional telephone associated with the gateway and the identifiers of the WiFi mobile telephones of the users who are associated with the gateway and liable to be connected when they are at home:

| | | WiFi telephones associated |
|---|---|---|
| | Traditional | with the gateway, and liable |
| Gateway | Telephone | to be connected to it |
| ID0165787654 | 0165787654 | Sip: 0676565432@ims; |
| | | Sip: 0656543456@ims; |
| | | Sip: 0635453425@ims |

The aim of this memory is to also store the different call options configured by the user.

The location server LS is an embodiment example of the location server according to the invention, which comprises:
a memory M for storing and associating:
   a residential gateway identifier, for example ID0165787654 for the gateway RGW,
   and at least one number identifying a mobile telephone, such as the WiFi mobile telephone T1 or the PC equipped with a telephony over Internet protocol software, connected at a given time to a radio interface of this residential gateway;
means for receiving, from an application server such as the server AS, a request containing a residential gateway identifier,
   and means for sending in this case to this application server one or more numbers identifying one or more mobile telephones connected to the residential gateway, if this is the case.
      For example, the memory M of the location server LS stores and associates the following numbers, for the example illustrated in FIG. 1:

| | WiFi telephones connected to the |
|---|---|
| Gateway | gateway at a given time |
| ID0165787654 | Sip: 0676565432@ims; |
| | Sip: 0656543456@ims |

In other embodiment examples, the number of the traditional telephone set can be used as the gateway identifier.

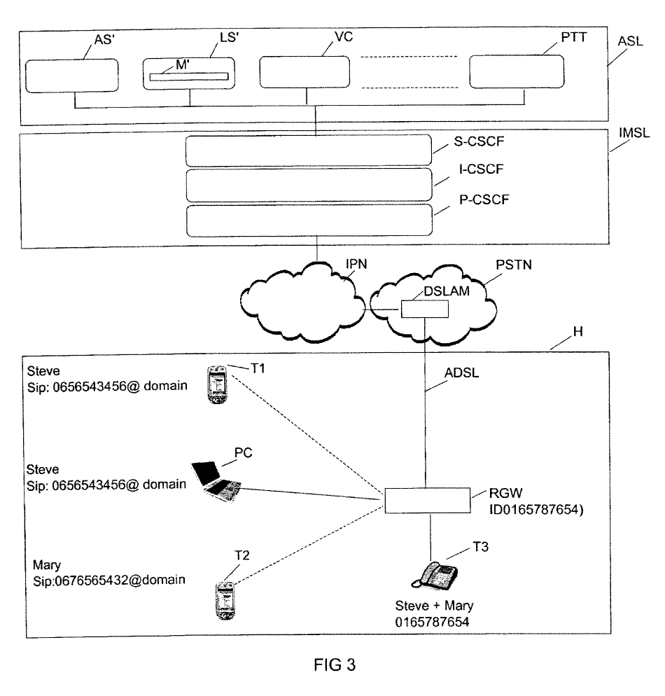

FIG. 3 shows in diagram form a SIP type telecommunication network, more specifically of the IMS type. It comprises a traditional IMS layer, with the reference IMSL, which essentially comprises:
a traditional proxy function P-CSCF which is the first point of contact of a terminal with the IMSL layer,
a traditional interrogation function I-CSCF which intervenes to authenticate and locate a subscriber,
a traditional service function S-CSCF which in particular manages the registration of subscribers present in the network.

This network also comprises an application server layer, ASL, which comprises for example: a telephony application server AS′, a location server LS′, a video application server VC, . . . , a “Push to Talk” application server PTT.
The telephony application server AS′ plays a similar role to that of the application server AS of the network described referring to FIG. 2. The location server LS′ plays a similar role to that of the location server LS′ of the network described referring to FIG. 2. It comprises a memory M′ similar to the memory M.

FIG. 4 shows a time diagram for signal exchanges during the operation of an embodiment example of the application server and of the location server according to the invention. More precisely, it represents an example in which Steve has chosen the option involving ringing his own WiFi mobile telephone T1, Mary's WiFi mobile telephone T2 and the traditional telephone T3 at the same time, configuring the application server accordingly.

The network concerned is a network supporting the SIP signaling protocol and the Internet protocol, and which may be the example shown in FIG. 2 (not IMS type) or the example shown in FIG. 3 (IMS type). In this example, the application server AS (or AS′ respectively) is configured to simultaneously ring the traditional telephone T3, Mary's WiFi mobile telephone T2 and Steve's WiFi mobile telephone T1 at the same time.

Step 41: John wants to telephone Mary and Steve's house. He dials the number 0165787654 which is the number identifying both the traditional telephone T3 and the residential gateway of Mary and Steve's home, with this number belonging to the telephone network numbering plan. A traditional signaling message INVITE sip: 0165787654 is routed to the application server AS.

Step 42: The application server AS then sends a request SLP INFO 0165787654 to the location server LS. A free field of this SIP request is used to ask which WiFi mobile terminals are currently connected to the WiFi interface of the residential gateway RWG, this being identified by the directory number 0165787654 contained in this request. In this example, Steve's WiFi telephone T1 and Mary's WiFi telephone T2 are connected to the gateway RGW. Steve's PC is not connected.

Step 43: The location server LS responds to the application server AS with a traditional 200 OK SIP message which contains, for the implementation of the invention, two uniform resource identifiers (this is a kind of telephone number, compatible with the SIP protocol). One identifier sip: 0676565432@domain designates Steve's WiFi telephone T1 and another identifier sip: 0656543456@do main designates Mary's WiFi telephone T2.

Step 44: The application server AS, after verification of the WiFi telephones associated with Mary and Steve's residence in the memory M″ and the different configured options, then sends a request:

INVITE 0165787654; sip: 0676565432@domain; sip: 0656543456@domain, addressed to a CC device (not shown on the other figures) which carries out the call control, in the IPN network, to request that three calls be set up respectively to the traditional telephone T3, the mobile telephone T2, and the mobile telephone T1.

Steps 45, 46, 47: The call control device, CC, then sends in parallel three call setup requests,
INVITE 0165787654, intended for the residential gateway RGW which acts as an interface for the traditional telephone T3,
INVITE sip: 0656543456@domain, intended for the WiFi telephone T2,
INVITE sip: 0676565432@domain, intended for the WiFi telephone T1.

Step 48: All the telephones ring together: The traditional telephone T3, Mary's WiFi telephone T2, and Steve's WiFi telephone T1. Mary does not answer. It is Steve who answers, taking the call on his WiFi telephone T1. Traditional SIP messages indicate, in return, that the terminals ring, but they are not shown on the figure so as not to overload the diagram.

Step 49: Steve's WiFi telephone T1 sends the call control device CC a 200-OK message indicating that Steve's WiFi telephone T1 is taking the call. A traditional SIP message indicates in return that John's telephone T4 has received this message, but it is not shown.

Step 50: The call is effectively set up between John's telephone T4 and Steve's WiFi telephone T1.

Steps 51, 52: As there is no need to continue ringing Mary's WiFi telephone T2 and the traditional telephone T3, the call control device CC then sends in parallel two call cancellation requests,
CANCEL 0165787654, intended for the residential gateway RGW which acts as an interface for the traditional telephone T3,
CANCEL sip: 0656543456@domain, intended for Mary's telephone T2.

In another configuration example, a user configures the application server AS to ring all the mobile telephones which are connected, but not to ring the traditional telephone. This server AS sends, during step 44, a request:

INVITE sip: 0676565432@domain; sip: 0656543456@domain,

addressed to the CC device which carries out the call control, to request the setting up of just two calls respectively to the mobile telephone T2 and to the mobile telephone T1. Therefore only the WiFi telephones are rung.

In another configuration example, a user configures the application server AS to ring only Steve's mobile telephone T1. The application server AS sends, during step 44, a request:
INVITE sip: 0656543456@domain,
   addressed to the CC device which carries out the call control, to request the setting up of just one call to Steve's mobile telephone T1.

In order to program these different configurations, the application server comprising means allowing a user to select one of the three operating methods described above. For example, Mary can access a dedicated website, using a traditional browser, and then choose one of the following three options:
To ring only her own WiFi telephone T2,
To ring only the two WiFi mobile telephones T1 and T2,
To ring the traditional telephone T3 and the two WiFi mobile telephones T1 and T2,
   when someone calls the number 0656543456 designating the gateway and the traditional telephone T3 in the numbering plan of the traditional network PSTN.

In an embodiment example, the location server LS comprises:
Software means for subscribing to the notifications of the presence of a traditional server (not shown). This presence server receives presence information containing the identifiers of the gateways to which the different SIP terminals of the operator are connected. As a result, the location server LS determines at each moment which WiFi telephones are connected to the residential gateway RGW. This location server LS may if necessary be hosted on the machine hosting this presence server or on the machine hosting the application server AS.
Software means for storing and associating:
   an identifier ID0165787654 identifying the residential gateway RGW,
   and a number for each mobile telephone T1, T2 connected, at the moment concerned, to a radio interface of this residential gateway.
Software means for receiving from the application server AS a request containing the identifier of the residential gateway RGW concerned.
Means for sending in this case to the application server AS a number for each mobile telephone connected, at the moment concerned, to the gateway identified by the residential gateway identifier, with this number being read in the storage means.

In another embodiment example, if the presence server allows it, the application server AS may interrogate (usually using the HTTP protocol) this presence server directly in order to determine which terminals are connected to the gateway RGW. When the INVITE message is intercepted by the server AS, this server interrogates the presence server, for each terminal identifier, associated with the gateway RGW in the memory M″, using for example the HTTP protocol. The presence server responds with a presence document for each terminal identifier. The server AS then determines, from the presence documents obtained, whether or not the terminal corresponding to the identifier is connected to the gateway RGW.

The invention applies to gateways other than residential ones, for example gateways used by companies. It applies both to fixed and mobile telephones, once they are connected to a gateway providing access to a network supporting the SIP protocol.

1) Application server for a telecommunication network supporting the SIP protocol, comprising:
means for receiving a request to set up a call to a number identifying a gateway,
means for then interrogating another device by sending it the number identifying this gateway, and so as to receive from this other device at least one number designating a telephone connected to this gateway,
and means for requesting that a call control device sets up at least one call to at least one telephone identified by a number received in this way;
and in which the means for requesting that a call control device set up at least one call comprise means for selecting at least one number from a range of numbers respectively designating telephones connected to this gateway, then requesting the setup of a call to each telephone designated by a number selected in this way.

2) Server according to claim 1, also comprising means for allowing a user to configure this server in such a way as to select in advance one or more telephones from among the telephones connected to said gateway.

3) Location server for terminals connected to a gateway, for a telecommunication network supporting the SIP protocol, comprising:
means for storing and associating:
a gateway identifier,
and a range of numbers respectively identifying a range of telephones connected to this gateway,
means for receiving, from another device, a request containing a gateway identifier,
and means for sending, in this case to this other device, a range of numbers identifying telephones connected to the gateway identified by this gateway identifier, with these numbers being read in the storage means.
